(19) United States
(12) Patent Application Publication
(10) Pub. No.: US 2014/0326915 A1
(43) Pub. Date: Nov. 6, 2014

(54) DIAPHRAGM VALVE

(71) Applicant: FUJIKIN INCORPORATED, Osaka-shi (JP)

(72) Inventors: Taichi Kitano, Osaka-shi (JP); Tsutomu Shinohara, Osaka-shi (JP); Michio Yamaji, Osaka-shi (JP); Ryutaro Nishimura, Osaka-shi (JP)

(73) Assignee: FUJIKIN INCORPORATED, Osaka-shi (JP)

(21) Appl. No.: 14/359,373

(22) PCT Filed: Nov. 27, 2012
(86) PCT No.: PCT/JP2012/080537

§ 371 Date: May 20, 2014

(30) Foreign Application Priority Data
Dec. 6, 2011 (JP) 2011-266922

(51) Int. Cl. F16K 7/12; F16K 25/00

(52) U.S. Cl. CPC F16K 7/12; F16K 25/005
USPC 251/331; 251/360

(57) ABSTRACT

There is provided a diaphragm valve configured to prevent a body from being scratched significantly even when replacement of a seat is repeated. A body 2, a seat 4 arranged on a peripheral edge of a fluid channel 2a formed on the body 2 so as to be demountably mountable, and a seat holder 5 arranged on the body 2 so as to be demountably mountable and configured to hold the seat 4 are provided. The body 2 and the seat holder 5 are each formed of a metal. Vickers hardness of the seat holder 5 is set to be smaller than Vickers hardness of the body 2.

### TECHNICAL FIELD

The present invention relates to a diaphragm valve and, specifically, to a diaphragm valve which allows a seat to be demountably mounted thereon and is held by a seat holder.

### BACKGROUND ART

As a diaphragm valve, the one including a body provided with a fluid channel, a seat arranged at a peripheral edge of the fluid channel formed in the body so as to be demountably mountable, a seat holder arranged on the body so as to be demountably mountable and configured to hold the seat, a diaphragm configured to open and close the fluid channel by being pressed against and moved away from the seat, a diaphragm holding member configured to clamp and hold an outer peripheral edge portion of the diaphragm in cooperation with the seat holder therebetween, and upward and downward moving means configured to move a diaphragm presser that presses a center portion of the diaphragm upward and downward is known (Patent Literature 1, and so forth).

In the diaphragm valve of the related art, the seat is held by the seat holder in demountably mountable manner and, when the seat is damaged, only the seat can be replaced.

### CITED REFERENCE

### Patent Literature

PTL1: JP-A-2003-42314

### SUMMARY

### Technical Problem

When mounting the seat holder, a substantial force may be applied between the body and the seat holder, and the diaphragm valve of the related art as described above has a problem that the body is damaged significantly when replacement of the seat is repeated.

It is an object of the present invention to provide a diaphragm valve configured to prevent a body from being scratched significantly even when replacement of a seat is repeated.

### Solution to Problem

A diaphragm valve according to the present invention includes a body provided with a fluid channel, a seat arranged at a peripheral edge of the fluid channel formed in the body so as to be demountably mountable, a seat holder arranged on the body so as to be demountably mountable and configured to hold the seat, a diaphragm configured to open and close the fluid channel by being pressed against and moved away from the seat, and upward and downward moving means configured to move the diaphragm presser that presses a center portion of the diaphragm upward and downward, characterized in that the body and the seat holder are each formed of a metal, and a Vickers hardness of the seat holder is set to be smaller than a Vickers hardness of the body.

When mounting the seat holder, there is a case where a significant force is applied between the body and the seat holder. However, since the Vickers hardness of the seat holder is smaller (for example, not more than 70%) than the Vickers hardness of the body, the body is prevented from being scratched by a deformation of the seat holder. Alternatively, even when the body gets some scratches or deformation, the scratches or the deformation may be restrained to a degree which does not impair the re-usability. The seat holder is easily replaceable, and hence a problem associated with the deformation of the seat holder is prevented by replacing the seat holder with a new one at the time of replacement of the seat. Accordingly, even when the seat replacement is repeated many times, the body can be used for a long time, and the reliability of the diaphragm valve is secured.

Setting the Vickers hardness of the seat holder to be smaller than the Vickers hardness of the body is achieved by changing heat-processing conditions or machining conditions with the same material (for example, stainless steel such as SUS316L), and hence a configuration in which the body is formed of a stainless steel such as generally used SUS316L or the like, and the seat holder is formed of a metal having a lower hardness than that of the body (for example, nickel alloy) is also applicable.

The diaphragm valve may be a manual valve having manually operated opening-closing handle as the upward and downward moving means, or may be an automatic valve having a suitable actuator as the upward and downward moving means. The actuator in the case of the automatic valve may be operated by fluid (air) pressure or by an electromagnetic force.

The seat is formed of, for example, a synthetic resin, but of course may be made of a metal.

The diaphragm is formed, for example, of a nickel alloy thin plate, and is formed into an inverted dish shape by cutting out into a circular shape and causing a center portion thereof to protrude upward. The diaphragm is formed, for example, of a stainless steel thin plate, or of a laminated member composed of a stainless steel thin plate and a nickel-cobalt alloy thin plate. The material of the diaphragm is not specifically limited. The diaphragm may be a single piece or a laminated member composed of a plurality of diaphragms, and may be selected freely depending on specifications or conditions.

The seat holder is, for example, a disc-shaped member having a hole therethrough and includes an inner peripheral edge portion configured to hold the seat, an intermediate annular portion formed with a plurality of through holes at a predetermined interval so as to be connected to a fluid outlet channel, and an outer peripheral edge portion configured to clamp an outer peripheral portion of the diaphragm.

In this specification, the direction of an axial line of the diaphragm (direction of resilient deformation) is defined as the upward and downward direction. However, this direction is defined only for the sake of convenience and, in the actual mounting, the upward and downward direction may be not only a perpendicular direction, but also a horizontal direction.

### Advantageous Effects of Invention

According to the diaphragm valve of the present invention, the body and the seat holder are both formed of a metal, and Vickers hardness of the seat holder is set to be smaller than the Vickers hardness of the body. Therefore, even when the replacement of the seat is repeated a plurality of times, the body can be used for a long time, and the reliability is secured.

### BRIEF DESCRIPTION OF DRAWINGS

FIG. 1 is a vertical cross-sectional view illustrating an embodiment of a diaphragm valve of the present invention.

FIG. 2 is an enlarged view of a seat holder of the diaphragm valve, in which (a) is a plan view and (b) is a vertical cross-sectional view.

### REFERENCE SIGNS LIST

(1) diaphragm valve, (2) body, (2a) fluid inflow channel, (2b) fluid outflow channel, (4) seat, (5) seat holder, (6) diaphragm, (8) diaphragm presser

### DESCRIPTION OF EMBODIMENTS

An embodiment of the present invention will be described with reference to the drawings.

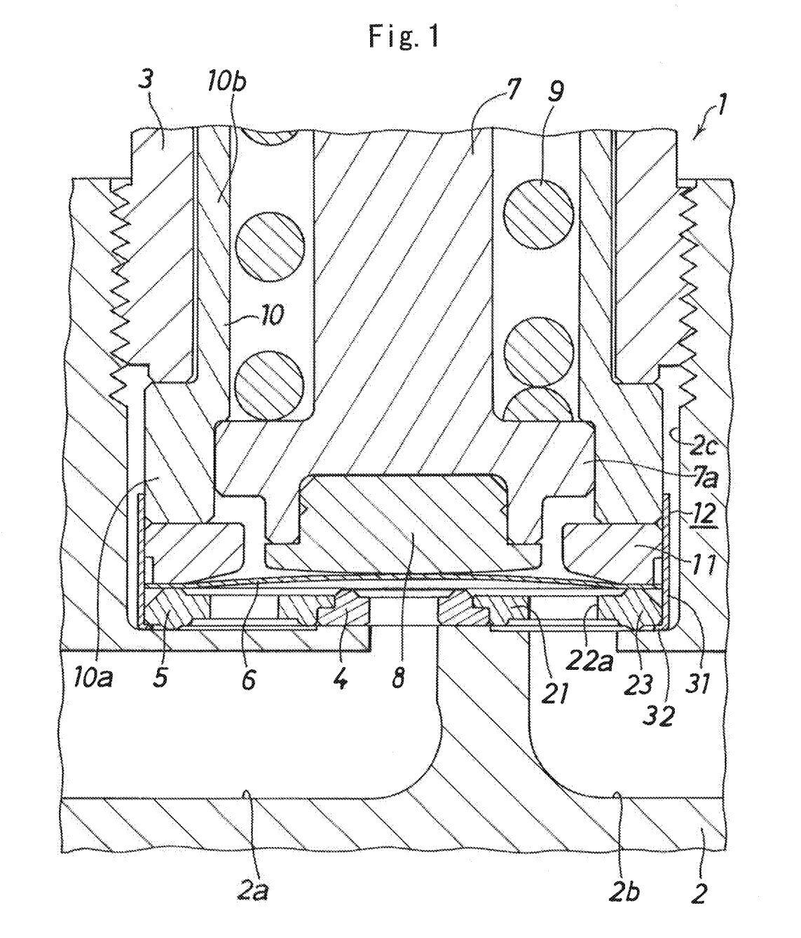

FIG. 1 illustrates an embodiment of the diaphragm valve of the present invention. A diaphragm valve (1) includes: a block body (2) including a fluid inlet channel (2a), a fluid outlet channel (2b), and a depressed portion (2c) opening upward; a cylindrical bonnet (3) screwed at a lower end thereof into an upper portion of the depressed portion (2c) of the body (2) and extending upward; an annular seat (4) provided on a peripheral edge of the fluid inlet channel (2a); a seat holder (5) provided on an outer periphery of the seat (4) in the body (2) and configured to hold the seat (4); a diaphragm (6) configured to be pressed against or moved away from the seat (4) to open and close the fluid channel (2a); a stem (7) having a diaphragm presser (8) configured to press the center portion of the diaphragm (6) at a lower end thereof and inserted into the bonnet (3) so as to be movable upward and downward to cause the diaphragm (6) to be pressed against or moved away from the seat (4) via the diaphragm presser (8); a compression coil spring (biasing member) (9) configured to bias the stem (7) downward; a guide cylinder (10) arranged in the inner periphery of the bonnet (3) to guide the upward and downward movement of the stem (7) and restrict a movable range of stem (7); a diaphragm holding ring (11) arranged between an upper surface of the outer peripheral edge portion of the diaphragm (6) and a lower end of the guide cylinder (10) to clamp the outer peripheral edge portion of the diaphragm (6) in corporation with an outer peripheral edge portion of the seat holder (5) therebetween; a retainer (12) mounted on a lower end portion of the guide cylinder (10) and the diaphragm holding ring (11) so as to be demountably mountable in a state of holding the seat holder (5); and an upward and downward moving means (not illustrated) configured to move the stem (7) and the diaphragm presser (8) with compressed air so as to open and close a fluid inlet channel (2a).

The guide cylinder (10) includes a thick portion (10a) and a thin portion (10b) continuing upward therefrom. An inner periphery of the thick portion (10a) has a diameter larger than an inner periphery of the thin portion (10b), and is configured to guide an outer periphery of a flange portion (7a) provided on the stem (7) by the inner periphery of the thick portion (10a). An outer periphery of the thick portion (10a) is larger in diameter than an outer periphery of the thin portion (10b), and a lower end surface of the bonnet (3) is received by an upper surface of the thick portion (10a) (a stepped surface between the thick portion (10a) and the thin portion (10b)). Therefore, the guide cylinder (10) presses the diaphragm holding ring (11) downward by screwing the bonnet (3) into the body (2). In this manner, the guide cylinder (10) is a member configured not only to guide the stem (7), but also to fix the diaphragm holding ring (11) to the body (2), and a combination of the guide cylinder (10) and the diaphragm holding ring (11) constitute a diaphragm holding member configured to clamp the outer peripheral edge portion of the diaphragm (6) in cooperation with the seat holder (5) therebetween.

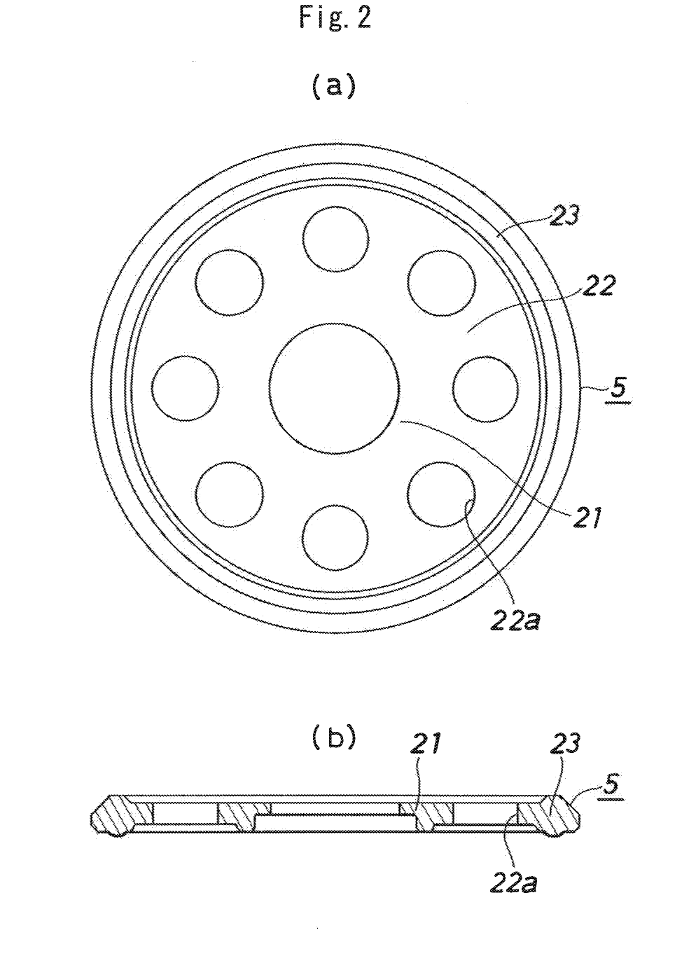

The seat holder (5) is formed of a metal and is a disc-shaped member having a hole therethrough and, as is illustrated in detail in FIG. 2, includes an inner peripheral edge portion (21) configured to hold the seat (4), an intermediate annular portion (22) formed with a plurality of through holes (22b) at a predetermined interval so as to be connected to a fluid outlet channel (2b), and an outer peripheral edge portion (23) configured to clamp an outer peripheral portion of the diaphragm (6). The seat (4) is fitted to the seat holder (5) from below.

The retainer (12) has a substantially cylindrical shape, and includes a peripheral wall (31) having an inner diameter which is substantially the same as an outer diameter of the seat (4) and fitted to an outer periphery of the lower end portion of the guide cylinder (10) and an outer periphery of the diaphragm holding ring (11), and an inwardly facing flange portion (32) provided at the lower end portion of the peripheral wail (31), and receiving the outer peripheral edge portion of the seat holder (5).

The seat (4) is held by a seat holder unit for a diaphragm valve composed of the seat holder (5) and the retainer (12), and is arranged in the body (2). The seat (4) is configured to be replaced normally after a certain period of use. When replacing the seat (4), the seat holder (5) and the seat (4) held thereby can be demounted by demounting the retainer (12). Then, the seat (4) is replaced and the seat holder (5) is replaced as needed, and the seat (4) is returned back into the body (2) in a state in which the seat (4) is held by the seat holder unit for a diaphragm valve, which is composed of the seat holder (5) and the retainer (12). In this manner, the replacement of the seat (4) can be performed easily. Since the retainer (12) has least possibility of being subjected to plastic deformation, repeated usage is normally possible, and ease of replacement of the seat (4) is maintained for a long time because of the least probability of being subjected to plastic deformation of the retainer (12).

In the related art, the body (2) and the seat holder (5) are both formed of stainless steel (SUS316L). However, in the case of the diaphragm valve (1) of the present invention, Vickers hardness of the seat holder (5) is set to be smaller than Vickers hardness of the body (2).

Table 1 shows a result of a test of presence of deformation of the body (2) (whether the body (2) is re-usable or not) in the case where Vickers hardness of the seat holder (5) is changed.

In Table 1, Vickers hardness of the body (2) is the same as the related art, which is HV230. The seat holder (5) having Vickers hardness (HV113) which is approximately half the Vickers hardness of the body (2) is used to mount and demount.

TABLE 1

| hardness | hardness of | hardness | deformation | re-usability |
|---|---|---|---|---|
| of body | seat holder | difference | of body | of body |
| HV230 | HV230 | absent | present | No |
| HV230 | HV113 | approximately | absent | Yes |
| | | half | | |

From the result in Table 1, it is found that deformation of the body (2) is avoided, and the body (2) can be re-used continuously by setting the Vickers hardness of the seat holder (5) to be smaller than the Vickers hardness of the body (2). An upper limit of the Vickers hardness of the seat holder (5) is preferably 70% of the Vickers hardness of the body (2). A lower limit of the Vickers hardness of the seat holder (5) is not specifically limited, but preferably is not smaller than HV90 in terms of ensuring the strength of the seat holder (5).

Although the retainer (12) is used in the diaphragm valve (1) described above, even though the diaphragm valve does not employ the retainer (12), an effect of prevention of the body (2) from being scratched is obtained as a matter of course by setting the Vickers hardness of the seat holder (5) to be smaller than the Vickers hardness of the body (2).

### INDUSTRIAL APPLICABILITY

The present invention contributes to the improvement of performance of the diaphragm valve used widely for opening and closing the fluid channel because the diaphragm valve configured to prevent the body from being significantly scratched even when the replacement of the seat is repeated is provided.

1. A diaphragm valve comprising: a body provided with a fluid channel; a seat formed on the body and arranged at a peripheral edge of the fluid channel formed in the body so as to be demountably mountable; a seat holder arranged on the body so as to be demountably mountable and configured to hold the seat; a diaphragm configured to open and close the fluid channel by being pressed against and moved away from the seat; and upward and downward moving means configured to move a diaphragm presser configured to press a center portion of the diaphragm, characterized in that
the body and the seat holder are each formed of a metal, and Vickers hardness of the seat holder is set to be smaller than Vickers hardness of the body.

2. The diaphragm valve according to claim 1, wherein the Vickers hardness of the body ranges from HV180 to HV300, and Vickers hardness of an inner disc ranges from HV90 to HV150.
